(19) United States
(12) Patent Application Publication
(10) Pub. No.: US 2025/0380099 A1
(43) Pub. Date: Dec. 11, 2025

(54) BONE-CONDUCTION MEMS CHIP AND MANUFACTURING METHOD THEREOF, AND BONE-CONDUCTION PACKAGING STRUCTURE HAVING BONE-CONDUCTION MEMS CHIP

(71) Applicant: AAC ACOUSTIC TECHNOLOGIES (SHENZHEN) CO., LTD., Shenzhen (CN)

(72) Inventors: Kaijie Wang, Shenzhen (CN); Bo Li, Shenzhen (CN); Rui Zhang, Shenzhen (CN)

(21) Appl. No.: 18/977,864

(22) Filed: Dec. 11, 2024

Related U.S. Application Data
(63) Continuation of application No. PCT/CN2024/097643, filed on Jun. 6, 2024.

(51) Int. Cl. H04R 31/00

(52) U.S. Cl. CPC H04R 31/00; H04R 2201/003; H04R 2460/13

(57) ABSTRACT

The present application provides a bone-conduction MEMS chip and a manufacturing method thereof, and a bone-conduction packaging structure having the bone-conduction MEMS chip. The bone-conduction MEMS chip includes a substrate having a cavity, a diaphragm supported on the substrate, and a back plate spaced apart on a side of the diaphragm away from the substrate. A side of the diaphragm away from the back plate is provided with a mass block. The mass block in the bone-conduction MEMS chip of the present application is formed directly on the diaphragm, and the bone-conduction packaging structure avoids setting the vibration sheet and the mass block additionally, resulting in lower costs, simpler packaging, and a smaller structure.

### CROSS-REFERENCE TO RELATED APPLICATIONS

This application is a continuation of International Application No. PCT/CN2024/097643, Jun. 6, 2024, the entire contents of which are incorporated herein by reference.

### TECHNICAL FIELD

The present application relates to the field of acoustic-electric conversion, in particular to a bone-conduction MEMS chip and a manufacturing method thereof, and bone-conduction packaging structure having the bone-conduction MEMS chip.

### BACKGROUND

The bone-conduction microphone converts the slight vibrations of the head and neck bones caused by speech into electrical signals. Unlike traditional microphones, which collect sound through air conduction, the bone-conduction microphone can accurately reproduce sound even in noisy environments. This design avoids noise interference caused by sound transmission through the air, significantly ensuring high sound quality.

In related art, the bone-conduction packaging structure includes a housing, a circuit board enclosed within the housing forming an accommodating space, a vibration assembly, and a Micro-Electro-Mechanical System (MEMS) chip. The vibration assembly includes a vibration plate positioned opposite to and spaced from the circuit board, a frame connecting the vibration plate and the circuit board, and a mass block mounted on the vibration assembly. When the bone-conduction packaging structure operates, the housing receives a vibration or pressure signal, which excites the vibration plate and the mass block. This excitation causes the vibration plate and mass block to vibrate, generating vibrations in the gas within the accommodating space. These vibrations lead to changes in air pressure within the accommodating space, which are detected by the MEMS chip. The MEMS chip converts the sensed pressure changes into detectable electrical signals and transmits them to the circuit board. However, the existing bone-conduction packaging structures are relatively large, have complex vibration assembly designs, are costly, and exhibit difficulty in adjusting sensitivity.

Therefore, it is necessary to provide a new bone-conduction packaging structure to solve the above technical problems.

### SUMMARY

An object of the present application is to provide a bone-conduction Micro-Electro-Mechanical System (MEMS) chip with high sensitivity.

In order to achieve the above objective, the technical solution of the present application is as follows: a bone-conduction MEMS chip, comprising: a substrate having a cavity, a diaphragm supported on the substrate, and a back plate spaced apart on a side of the diaphragm away from the substrate, wherein a side of the diaphragm away from the back plate is provided with a mass block.

In one embodiment, the bone-conduction MEMS chip further comprises a connecting post connecting the mass block to the side of the diaphragm away from the back plate.

In one embodiment, the mass block is located in the cavity and the mass block is made of the same material as the substrate.

In contrast to the related art, the present application provides a bone-conduction MEMS chip, which includes a substrate having a cavity, a diaphragm supported on the substrate, and a back plate spaced apart on the side of the diaphragm away from the substrate. A side of the diaphragm away from the back plate is provided with a mass block. By directly setting the mass block on the diaphragm of the bone-conduction MEMS chip, the present application makes the sensitivity of the bone-conduction MEMS chip flexibly adjustable by directly adjusting the size of the mass block, which is highly practical.

A further object of the present application is to provide a method of manufacturing a bone-conduction MEMS chip with high sensitivity.

In order to achieve the above object, the technical solution of the present application is as follows: a method of manufacturing a bone-conduction MEMS chip, comprising:
providing a substrate;
depositing a first silicon oxide layer on the substrate, etching the first silicon oxide layer to form a groove on the first silicon oxide layer extending to a surface of the substrate;
depositing a polysilicon layer to cover the first silicon oxide layer, forming a connecting post by extending the polysilicon layer partially into the groove, and patterning the polysilicon layer on the surface of the first silicon oxide layer to form a diaphragm, wherein the diaphragm is connected to the connecting post;
depositing a second silicon dioxide layer on the surface of the diaphragm;
depositing a back plate material layer on the surface of the second silicon dioxide layer, etching the back plate material layer to form a plurality of through holes;
reverse etching the substrate to form a cavity and a mass block attached to the diaphragm, and etching the first silicon oxide layer below the diaphragm; and
etching the first silicon dioxide layer above the diaphragm through the through holes to release the diaphragm.

In one embodiment, the step of patterning the polycrystalline silicon layer on the surface of the first silicon oxide layer to form the diaphragm comprises: forming a through-hole in the diaphragm.

In one embodiment, the step of depositing the back plate material layer on the surface of the second silicon dioxide layer comprises: depositing a back plate electrode material layer and etching the back plate electrode material layer to form a back plate electrode, and depositing a silicon nitride layer on the back plate electrode and patterning the silicon nitride layer to form a back plate.

In one embodiment, the step of depositing the first silicon dioxide layer on the surface of the diaphragm comprises: etching the first silicon dioxide layer to form a first recessed portion;
the step of depositing the back plate electrode material layer and etching the back plate electrode material layer to form the back plate electrode comprises: forming a second recessed portion on the back plate electrode aligned with the first recessed portion;
the step of depositing the silicon nitride layer on the back plate electrode and patterning the silicon nitride layer to form the back plate comprises: forming a protruding portion on the back plate accommodated within the first recessed portion and the second recessed portion.

In one embodiment, the step of reverse etching the substrate forming the cavity and the mass block attached to the diaphragm comprises two etchings, wherein the substrate is etched forming a portion of the cavity in the first etching, and a mass block attached to the diaphragm is formed in the second etching.

In one embodiment, after forming the mass block, the method further comprises: etching the first silicon oxide layer below the diaphragm.

In contrast to the related art, the present application provides a method of manufacturing a bone-conduction MEMS chip comprising the steps of: providing a substrate; depositing a first silicon oxide layer on the substrate, etching the first silicon oxide layer to form a groove on the first silicon oxide layer extending to a surface of the substrate; depositing a polysilicon layer to cover the first silicon oxide layer, forming a connecting post by extending the polysilicon layer partially into the groove, and patterning the polysilicon layer on the surface of the first silicon oxide layer to form a diaphragm, wherein the diaphragm is connected to the connecting post; depositing a second silicon dioxide layer on the surface of the diaphragm; depositing a back plate material layer on the surface of the second silicon dioxide layer, etching the back plate material layer to form a plurality of through holes; reverse etching the substrate to form a cavity and a mass block attached to the diaphragm, and etching the first silicon oxide layer below the diaphragm; and etching the first silicon dioxide layer above the diaphragm through the through holes to release the diaphragm. By directly setting the mass block on the diaphragm of the bone-conduction MEMS chip, the present application makes the sensitivity of the bone-conduction MEMS chip flexibly adjustable by directly adjusting the size of the mass block, which is highly practical.

An object of the present application is to provide a bone-conduction packaging structure with a small size, low cost, and simple structure.

In order to achieve the above-mentioned object, the technical solution of the present application is as follows: the bone-conduction packaging structure comprises: a substrate, a housing that forms an accommodating space with the substrate, a bone-conduction MEMS chip and an ASIC chip disposed in the accommodating space. The bone-conduction MEMS chip is the aforementioned bone-conduction MEMS chip.

Compared with the related art, the bone-conduction packaging structure provided by the present application avoids separately setting the vibration sheet and the mass block in the bone-conduction packaging structure by directly setting the mass block on the diaphragm of the bone-conduction MEMS chip, resulting in lower costs, simpler packaging, and a smaller structure.

### BRIEF DESCRIPTION OF THE DRAWINGS

The technical solutions in the embodiments of the present invention will be clearly and completely described below in conjunction with the accompanying drawings in the embodiments of the present invention. Obviously, the accompanying drawings in the following description are only some embodiments of the present application, and for the person of ordinary skill in the field of the present application, other accompanying drawings may be obtained based on these drawings without putting forth any creative labor.

FIG. 1 shows a three-dimensional structural schematic diagram of a bone-conduction MEMS chip of the present application.

FIG. 2 shows a cross-sectional view of a bone-conduction packaging structure of the present application.

FIGS. 3a to 3h are flowcharts of a manufacturing process of the bone-conduction MEMS chip as shown in FIG. 1.

### DETAILED DESCRIPTION OF THE EMBODIMENTS

The technical solutions in the embodiments of the present application will be described clearly and completely in the following in conjunction with the accompanying drawings in the embodiments of the present application. Obviously, the described embodiments are only a part of the embodiments of the present application and not all of the embodiments. Based on the embodiments in the present application, all other embodiments obtained by a person of ordinary skill in the art without making creative labor fall within the scope of protection of the present application.

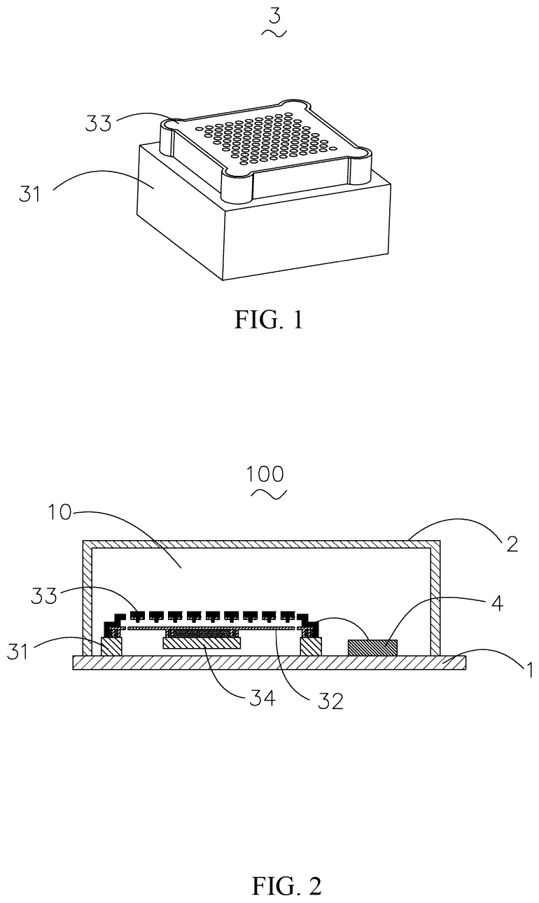

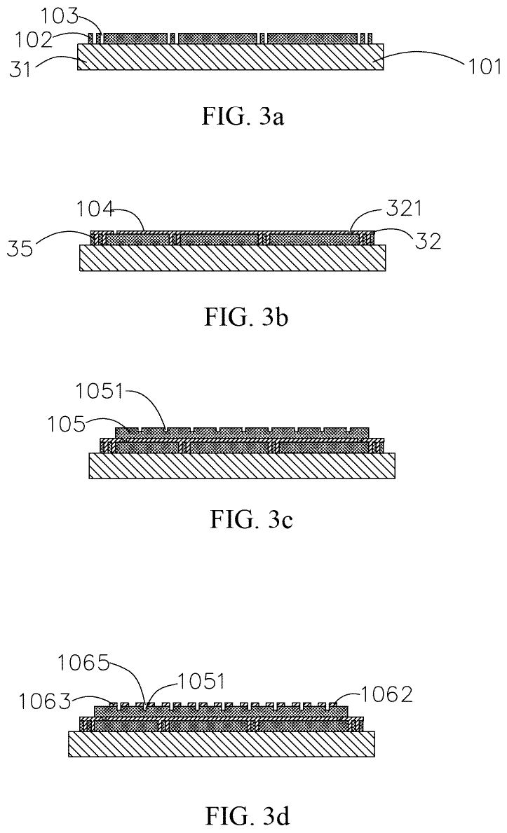

As shown in FIGS. 1 and 2, the present application provides a bone-conduction packaging structure 100, which includes a substrate 1, a housing 2 capped with the substrate 1 to form an accommodating space 10, a bone-conduction MEMS chip 3 and an ASIC chip 4 provided within the accommodating space 10.

The substrate 1 is a circuit board and the housing 2 may be a metal housing.

The bone-conduction MEMS chip 3 includes a substrate 31 having a cavity 310, a diaphragm 32 supported on the substrate 31, and a back plate 33 spaced apart on a side of the diaphragm 32 away from the substrate 31. A side of the diaphragm 32 away from the back plate 33 is provided with a mass block 34. The mass block 34 is made of the same kind of material as the substrate 31. The bone-conduction MEMS chip 3 further includes a connecting post 35 connecting the mass block 34 to a side of the diaphragm 32 away from the backing plate 33, and the mass block 34 is provided within the cavity 310. By directly setting the mass block 34 on the diaphragm 32 of the bone-conduction MEMS chip 3, the present application makes the sensitivity of the bone-conduction MEMS chip 3 flexibly adjustable by directly adjusting the size of the mass block 34, which is practical. Meanwhile, the bone-conduction packaging structure 100 provided by the present application avoids additionally setting up vibrating sheets and mass blocks within the accommodating space 10, resulting in lower cost, simpler encapsulation, and smaller structure.

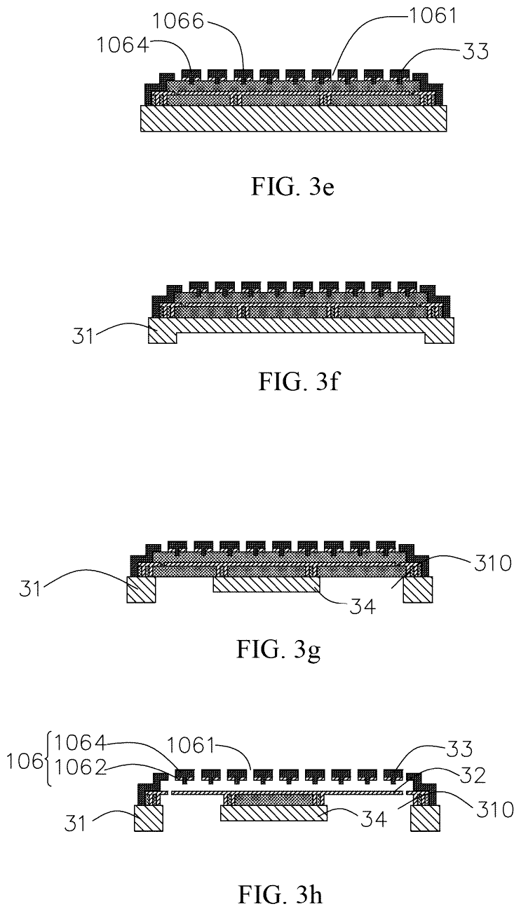

As shown in FIGS. 3a to 3h, the present application further provides a method of manufacturing a bone-conduction MEMS chip 3, which includes the following steps.

A substrate material 101 to manufacture a substrate 31 is provided.

A first silicon oxide layer 102 on the substrate 31 is deposited, the first silicon oxide layer 102 is etched to form a plurality of grooves 103 on the first silicon oxide layer 102 extending to the surface of the substrate 31.

A polysilicon layer 104 is deposited to cover the first silicon oxide layer 102, a connection post 35 is formed by extending the polysilicon layer 104 partially into the grooves 103, and the polysilicon layer 104 is patterned on the surface of the first silicon oxide layer 102 to form a diaphragm 32. The diaphragm 32 is connected to the connection post 35.

A second silicon dioxide layer 105 is deposited on the surface of the diaphragm 32, and the second silicon dioxide layer 105 is etched to form a plurality of first recessed portions 1051.

A back plate material layer 106 is deposited on the surface of the second silicon dioxide layer 105, and the back plate material layer 106 is etched to form a plurality of through holes 1061. The back plate material layer 106 includes a back plate electrode material 1062 and a silicon nitride layer 1064, and the step of depositing the back plate material layer 106 includes: depositing the back plate electrode material layer 1062 on the second silicon dioxide layer 105 and etching the back plate electrode material layer 1062 to form a back plate electrode 1063; forming a second recessed portion 1065 on the back plate electrode 1063 aligned with the first recessed portion 1051; and depositing a silicon nitride layer 1064 on the back plate electrode 1063 and patterning the silicon nitride layer 1064 to form the back plate 33. The silicon nitride layer 1064 is filled into the first recessed portion 1051 and the second recessed portion 1065 such that the back plate 33 forms a protruding portion 1066 accommodated within the first recessed portion 1051 and the second recessed portion 1065.

The substrate 31 is reverse etched to form a cavity 310 and a mass block 34 attached to the diaphragm 32, and a first silicon oxide layer 102 below the diaphragm 32 is etched. The above step specifically includes: first forming the cavity 310 and the mass block 34 by two etchings. Specifically, the substrate 31 is etched to form a portion of the cavity 310 in the first etching. In this circumstance, the remaining thickness of the substrate 31 is the thickness of the mass block 34, the thickness of the mass block 34 is a thickness of the substrate 31, and the thickness of the mass block 34 is adjustable according to requirements. The mass block 34 attached to the diaphragm 32 is formed in the second etching, and the mass block 34 is located at the middle position of the diaphragm 32. After forming the mass block 34, the first silicon oxide layer 102 below the diaphragm 32 is etched.

The silicon dioxide layer 106 above the diaphragm 32 is etched through the through-hole 1061 to release the diaphragm 32 so that the diaphragm 32 has full space to vibrate up and down.

The diaphragm 32 of the bone-conduction MEMS chip 3 is supported on the substrate 31 by the connecting post 35 and a portion of the first silicon oxide layer 102, which portion of the first silicon oxide layer 102 is the first silicon oxide layer 102 between the adjacent connecting posts 35 and between the connecting post 35 and the back plate 33. The mass block 34 is also supported on the substrate 31 by the connecting post 35 and a portion of the first silicon oxide layer 102 is connected to the diaphragm 32, which portion of the first silicon oxide layer 102 is the first silicon oxide layer 102 between the adjacent connecting posts 35 in the center region of the diaphragm 32.

A protruding portion 1066 on the back plate 33 prevents the diaphragm 32 from bonding to the back plate 33 when the diaphragm 32 vibrates.

In contrast to related art, the present application provides a bone-conduction MEMS chip, which includes a substrate having a cavity, a diaphragm supported on the substrate, and a back plate spaced apart on the side of the diaphragm away from the substrate. A side of the diaphragm away from the back plate is provided with a mass block. By directly setting the mass block on the diaphragm of the bone-conduction MEMS chip, the present application makes the sensitivity of the bone-conduction MEMS chip flexibly adjustable by directly adjusting the size of the mass block, which is highly practical.

Compared with the related art, the present application directly forms a mass block on the diaphragm of the bone-conduction MEMS chip by etching twice, and the thickness and size of the mass block can be flexibly adjusted, so that the sensitivity of the bone-conduction MEMS chip can be flexibly adjusted by directly adjusting the size of the mass block, which is highly practical.

Compared with the related art, in the bone-conduction packaging structure provided by the present application, a mass block is directly set on the diaphragm of the bone-conduction MEMS chips, avoiding the need to set up a separate vibrating sheet and mass block in the bone-conduction packaging structure, resulting in lower costs, simpler packaging, and a smaller structure.

Described above are only embodiments of the present application, and it should be pointed out that, for the ordinary technical personnel in the field, improvements may also be made without departing from the premise of the concept of the present application, but these are all within the protection scope of the present application.

What is claimed is:

1. A bone-conduction MEMS chip comprising:
a substrate having a cavity;
a diaphragm supported on the substrate; and
a back plate spaced apart on a side of the diaphragm away from the substrate, wherein a side of the diaphragm away from the back plate is provided with a mass block.

2. The bone-conduction MEMS chip of claim 1, further comprising a connecting post connecting the mass block to the side of the diaphragm away from the back plate.

3. The bone-conduction MEMS chip of claim 1, wherein the mass block is located in the cavity and the mass block is made of the same material as the substrate.

4. A method of manufacturing a bone-conduction MEMS chip, comprising:
providing a substrate;
depositing a first silicon oxide layer on the substrate, etching the first silicon oxide layer to form a groove on the first silicon oxide layer extending to a surface of the substrate;
depositing a polysilicon layer to cover the first silicon oxide layer, forming a connecting post by extending the polysilicon layer partially into the groove, and patterning the polysilicon layer on the surface of the first silicon oxide layer to form a diaphragm, wherein the diaphragm is connected to the connecting post;
depositing a second silicon dioxide layer on the surface of the diaphragm;
depositing a back plate material layer on the surface of the second silicon dioxide layer, etching the back plate material layer to form a plurality of through holes;
reverse etching the substrate to form a cavity and a mass block attached to the diaphragm, and etching the first silicon oxide layer below the diaphragm; and
etching the first silicon dioxide layer above the diaphragm through the through holes to release the diaphragm.

5. The method of manufacturing the bone-conduction MEMS chip of claim 4, wherein the step of patterning the polycrystalline silicon layer on the surface of the first silicon oxide layer to form the diaphragm comprises: forming a through-hole in the diaphragm.

6. The method of manufacturing the bone-conduction MEMS chip of claim 4, wherein the step of depositing the back plate material layer on the surface of the second silicon dioxide layer comprises: depositing a back plate electrode material layer and etching the back plate electrode material layer to form a back plate electrode, and depositing a silicon nitride layer on the back plate electrode and patterning the silicon nitride layer to form a back plate.

7. The method of manufacturing the bone-conduction MEMS chip of claim 6, wherein the step of depositing the first silicon dioxide layer on the surface of the diaphragm comprises: etching the first silicon dioxide layer to form a first recessed portion;
the step of depositing the back plate electrode material layer and etching the back plate electrode material layer to form the back plate electrode comprises: forming a second recessed portion on the back plate electrode aligned with the first recessed portion;
the step of depositing the silicon nitride layer on the back plate electrode and patterning the silicon nitride layer to form the back plate comprises: forming a protruding portion on the back plate accommodated within the first recessed portion and the second recessed portion.

8. The method of manufacturing the bone-conduction MEMS chip of claim 4, wherein the step of reverse etching the substrate forming the cavity and the mass block attached to the diaphragm comprises two etchings, wherein the substrate is etched forming a portion of the cavity in the first etching, and a mass block attached to the diaphragm is formed in the second etching.

9. The method of manufacturing the bone-conduction MEMS chip of claim 8, wherein after forming the mass block, the method further comprises: etching the first silicon oxide layer below the diaphragm.

10. A bone-conduction packaging structure, comprising:
a substrate;
a housing that forms an accommodating space with the substrate;
a bone-conduction MEMS chip provided in the accommodating space; and
an ASIC chip provided in the accommodating space, wherein the bone-conduction MEMS chip is the bone-conduction MEMS chip described in claim 1.
